(19) United States
(12) Patent Application Publication
(10) Pub. No.: US 2025/0054999 A1
(43) Pub. Date: Feb. 13, 2025

(54) FIRED BODY AND FUEL CELL USING THE FIRED BODY

(71) Applicant: NISSAN CHEMICAL CORPORATION, Tokyo (JP)

(72) Inventors: Shoichi KONDO, Funabashi-shi (JP); Takuji YOSHIMOTO, Funabashi-shi (JP); Norihito SHIGA, Funabashi-shi (JP)

(73) Assignee: NISSAN CHEMICAL CORPORATION, Tokyo (JP)

(21) Appl. No.: 18/717,816

(22) PCT Filed: Dec. 9, 2022
(86) PCT No.: PCT/JP2022/045426

§ 371 Date: Jun. 7, 2024

(30) Foreign Application Priority Data
Dec. 10, 2021 (JP) 2021-200931

(51) Int. Cl. H01M 4/96; H01M 8/1004; H01M 8/1018

(52) U.S. Cl. CPC H01M 4/96; H01M 8/1004; H01M 8/1018

(57) ABSTRACT

The aggregation of solids in a catalyst ink used for the fabrication of catalyst layers for a fuel cell is eliminated or reduced to allow the ink to attain improved applicability and by that to offer improved power generation characteristics when used in a catalyst layer for a fuel cell. For example, the present invention resides in a fired body from a mixture including graphene oxide and a nitrogen-containing compound component.

### FIELD OF THE INVENTION

The present invention relates to a fired body and a fuel cell using the fired body.

### BACKGROUND ART

Graphene oxide, which is graphene with oxygen functional group, is single-layered sheets separated by the oxidation reaction of graphite. Graphite, also known as black lead, is a sheet from one layer to more layers of graphene, a element mineral consisting of carbon, has a hexagonal structure and honeycomb-shaped layered material. The layers are bonded with a weak van der Waals force and thus can be separated.

As known in the art, graphene oxide can be synthesized mainly by the following three methods: the Brodie method (Non Patent Literature 1), the Staudenmaier method (Non Patent Literature 2), and the Hummers method (Non Patent Literature 3).

A review of a reduction method has been reported in which graphene oxide is reduced using, for example, hydrazine, sodium borohydride, ascorbic acid, or hydrogen iodide (Non Patent Literature 4).

Methods for preparing nitrogen-containing carbon materials and carbon nitrides are known (Non Patent Literature 5).

Because of their insolubility in organic solvents, carbon nitride materials that are nitrogen-containing carbon materials are difficult to form into thin films and are not suited for wet processes (Patent Literature 1).

### PRIOR ART REFERENCES

### Patent Literature

Patent Literature 1: Japanese Patent Application Kokai Publication No. 2013-237308

### Non Patent Literature

Non Patent Literature 1: Soc. Lond., B Biol. Sci., 1859, vol. 149, pp. 248-259
Non Patent Literature 2: Ber. Dtsch. Chem. Ges., 1898, vol. 31, pp. 1481-1487
Non Patent Literature 3: J. Am. Chem. Soc., 1958, vol. 80, p. 1339
Non Patent Literature 4: Chem. Soc. Rev., 2014, vol. 43 (1), pp. 291-312
Non Patent Literature 5: Carbon material experiment technology (production and synthesis), [Chapter 4:4-3 The art of preparing nitrogen-enriched carbon materials], edited by The Carbon Society of Japan, the serial course editorial board, 2013, pp. 267-270

### SUMMARY OF INVENTION

### Problems to be Solved by the Invention

Graphene oxide which behaves as an insulator can attain conductivity by reducing graphene oxide by hydrazine into reduced graphene oxide. While graphene oxide attains conductivity by being reduced, the reduced graphene oxide tends to be poorly dispersible in catalyst inks in contrast to the previous form, graphene oxide.

Regarding the dispersibility in catalyst inks when reduced graphene oxide is used in a catalyst layer for a fuel cell, various components, such as materials and catalysts, are dispersed into a solvent to give a catalyst ink, and the catalyst ink thus prepared is applied to a substrate to form a catalyst layer. When reduced graphene oxide with poor dispersibility is added to the catalyst ink, solids tend to be aggregated in the catalyst ink and often make the applicability of the ink to be difficult.

When a catalyst ink is prepared a nitrogen-containing carbon material, for example, graphitic carbon nitride (g-C₃N₄) or carbon nitride is added to the catalyst ink, such a nitrogen-containing carbon material often encounters difficulties in being dispersed in the catalyst ink without being dissolved or melted.

An object of the present invention is to suppress the aggregation of solids in a catalyst ink used for the fabrication of catalyst layers for a fuel cell and thereby to allow the ink to attain improved applicability and by that to offer improved power generation characteristics when used in a catalyst layer for a fuel cell.

### Means for Solving the Problems

As a result of studies, the present inventors have developed a novel fired body obtained by firing a mixture containing graphene oxide, a nitrogen-containing compound component, and optionally an aromatic compound having a phenolic hydroxyl group, and have found that the fired body is useful as, for example, an electrolyte and/or a catalyst carrier in a catalyst layer for a fuel cell and also as an electrolyte in a solid electrolyte membrane to allow the catalyst layer to attain improvements in ion conductivity, electron conductivity, water transport, and gas permeability and thereby to offer excellent power generation characteristics. Furthermore, the present inventors have found that the fired body does not cause aggregation of solids in a catalyst ink for the fabrication of catalyst layers for a fuel cell, and improved applicability can be obtained.

Aspects of the present invention based on the above findings reside in, for example, the following [1] to [14].
[1] A fired body of a mixture including graphene oxide and a nitrogen-containing compound component.
[2] The fired body according to [1], wherein the mixture further includes an aromatic compound having a phenolic hydroxyl group.
[3] The fired body according to [1] or [2], wherein the mixture further includes a rare earth metal compound.
[4] The fired body according to any one of [1] to [3], wherein the nitrogen-containing compound component is at least one kind selected from the group consisting of nitrogen-containing compounds, salts of nitrogen-containing compounds, and resins containing a constituent unit derived from a nitrogen-containing compound.
[5] The fired body according to any one of [2] to [4], wherein the aromatic compound having a phenolic hydroxyl group is an aromatic compound having 3 to 6 phenolic hydroxyl groups.
[6] The fired body according to any one of [3] to [5], wherein the metal in the rare earth metal compound is at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium.
[7] The fired body according to any one of [1] to [6], which comprises a three-dimensional polymer of the nitrogen-containing compound.
[8] The fired body according to any one of [2] to [7], which comprises a three-dimensional polymer of the aromatic compound having a phenolic hydroxyl group.
[9] The fired body according to any one of [1] to [8], which is at least one kind of an electrolyte in a catalyst layer, a catalyst carrier in a catalyst layer, or an electrolyte in a solid electrolyte membrane, in a polymer electrolyte fuel cell.
[10] A composition including the fired body of any one of [1] to [9] and a metal catalyst.
[11] The composition according to which is for use in a catalyst layer for a polymer electrolyte fuel cell.
[12] A catalyst layer for a polymer electrolyte fuel cell including the composition of [11].
[13] A membrane-electrode assembly including a solid electrolyte membrane, a gas diffusion layer, and the catalyst layer for a polymer electrolyte fuel cell of [12].
[14] A polymer electrolyte fuel cell including the membrane-electrode assembly of [13].

### Effects of Invention

The fired body of the present invention suppress aggregation of solids in a catalyst ink used for the fabrication of catalyst layers for a fuel cell and thereby allows the ink to attain improved applicability and by that to offer improved power generation characteristics when used in a catalyst layer for a fuel cell.

### BRIEF DESCRIPTION OF THE DRAWINGS

FIG. 1 is a sectional view schematically illustrating a configuration of a polymer electrolyte fuel cell.

### MODE FOR CARRYING OUT THE INVENTION

As used herein, “n” means normal, “s-” secondary, “t” tertiary, “o” ortho, “m-” meta, and “p-” para. As used herein, the term “polymer” means both homopolymer and copolymer.

### <<Fired Bodies>>

The present invention pertains to a fired body from a mixture comprising graphene oxide and a nitrogen-containing compound component. From the point of view of power generation characteristics, the present invention preferably pertains to a fired body from a mixture comprising an aromatic compound having a phenolic hydroxyl group, graphene oxide, and a nitrogen-containing compound component, a fired body from a mixture comprising a rare earth metal compound, graphene oxide, and a nitrogen-containing compound component, and a fired body from a mixture comprising a rare earth metal compound, an aromatic compound having a phenolic hydroxyl group, graphene oxide, and a nitrogen-containing compound component.

### <Graphene Oxide>

The mixture to be fired bodies comprises graphene oxide.

Graphene oxide is a single-layered structure obtained by the oxidization of graphite (black lead). Graphite oxide is a stack of oxidized graphite layers. Graphene oxide may also indicate a dispersion obtained by, for example, ultrasonicating graphite oxide in a solvent. For example, the Brodie method, the Staudenmaier method, and the Hummers method are known as graphite oxidation methods. The graphene oxide may be one prepared by oxidizing graphite by the above method or may be commercially available graphene oxide. A freeze-dried product of graphene oxide dispersed in a solution may also be used.

The graphene oxide is preferably insulating graphene oxide.

Specific examples include Graphene Oxide (10 mg/mL, Dispersion in Water) (manufactured by Tokyo Chemical Industry Co., Ltd.), aqueous graphene oxide solutions GO-W-60 and GO-W-175, highly concentrated aqueous graphene oxide solutions HCGO-W-60, HCGO-W-175, and HCGO-W-IL (manufactured by ALLIANCE Biosystems, Inc.), Rap GO (TQ-11)-0.01, Rap GO (TQ-11)-0.1, Rap GO (TQ-11)-1, Rap GO (TQ-11)-10, and Rap GO (TQ-11)-10L (manufactured by Nishina materials Co. Ltd.), and 1.0 wt % aqueous graphene oxide dispersion (manufactured by EMD Millipore). 1.0 wt % aqueous graphene oxide dispersion (manufactured by EMD Millipore) is preferable.

### <Nitrogen-Containing Compound Components>

The mixture to be fired bodies comprises a nitrogen-containing compound component.

Examples of the nitrogen-containing compound components include nitrogen-containing compounds, salts of nitrogen-containing compounds, and resins containing a constituent unit derived from a nitrogen-containing compound. The components may be used singly, or two or more may be used in combination. Preferred nitrogen-containing compound components are nitrogen-containing compounds and salts of nitrogen-containing compounds. Nitrogen-containing compounds are more preferable.

Examples of the nitrogen-containing compounds include urea, aromatic urea compounds, guanidine compounds, triazine heterocyclic compounds, and nitrogen-containing condensed ring compounds.

Examples of the aromatic urea compounds include phenylurea, benzylurea, N-ethyl-N′-phenylurea, p-ethoxyphenylurea, N,N′-diphenylurea, N,N-diphenylurea, tetraphenylurea, and benzoylurea.

Examples of the guanidine compounds include guanidine, methylguanidine, nitroguanidine, aminoguanidine, biguanide, dicyandiamide, carbamoylguanidine, glycocyamine, creatine, N,N′-diphenylguanidine, triphenylguanidine, and guanidine carbonate. Guanidine, aminoguanidine, and guanidine carbonate are preferable.

Examples of the triazine heterocyclic compounds include 1,3,5-triazine, cyanuric chloride, cyanuric acid, trimethyl cyanurate, methyl isocyanurate, ethyl isocyanurate, melamine, melem, melam, ammeline, ammelide, benzoguanamine, methylguanamine, 1,3,5-trimethyltriazine, 1,3,5-triphenyltriazine, ammeline-¹³C₃, ammelide-¹³C₃, thiocyanuric acid, diaminomercaptotriazine, diaminomethyltriazine, diaminophenyltriazine, and diaminoisopropoxytriazine. Melamine is preferable.

Examples of the nitrogen-containing condensed ring compounds include purine, xanthine, caffeine, uric acid, adenine, guanine, 2,6-diaminopurine, 2,4,6-triaminopyridine, 3-methyluric acid, and 7-methyluric acid.

The nitrogen-containing compounds may be used singly, or two or more may be used in combination. The nitrogen-containing compound preferably has 3 or more functional groups because such a compound can form a three-dimensional polymer as will be described later.

Examples of the resins containing a constituent unit derived from a nitrogen-containing compound include melamine resins. Melamine resins are polycondensation products of melamine, which is a nitrogen-containing compound, or a derivative thereof with an aldehyde compound. Examples of melamine and the derivatives thereof include methylolmelamine and benzoguanamine. Examples of the aldehyde compounds include formaldehyde. Melamine and the derivatives thereof, and the aldehyde compounds may be each used singly, or two or more may be used in combination.

Commercially available melamine resins may also be used. Examples of the commercially available products include those under the product names CYMEL 202, CYMEL 203, CYMEL 204, CYMEL 211, CYMEL 212, CYMEL 238, CYMEL 251, CYMEL 253, CYMEL 254, CYMEL 303, CYMEL 323, CYMEL 324, CYMEL 325, CYMEL 327, CYMEL 350, CYMEL 370, CYMEL 380, CYMEL 385, CYMEL 1156, CYMEL 1158, CYMEL 1116, and CYMEL 1130 (manufactured by Allnex Japan Inc); RESIMINE 735, RESIMINE 740, RESIMINE 741, RESIMINE 745, RESIMINE 746, and RESIMINE 747 (manufactured by Monsanto Company); U-VAN 120, U-VAN 20HS, U-VAN 20SE, U-VAN 2021, U-VAN 2028, and U-VAN 28-60 (manufactured by Mitsui Chemicals, Inc.); and SUMIMAL M55, SUMIMAL M30W, and SUMIMAL M50W (manufactured by SUMITOMO CHEMICAL COMPANY, LIMITED). These may be used singly, or two or more may be used in combination.

In the salts of nitrogen-containing compounds, the acids that form salts with the nitrogen-containing compounds are not particularly limited. Examples thereof include hydrochloric acid, sulfuric acid, phosphoric acid, polyphosphoric acid, sulfamic acid, nitric acid, perchloric acid, carbonic acid, hydroiodic acid, hydrobromic acid, and thiocyanic acid.

Exemplary salts of cyanuric acid or isocyanuric acid as the nitrogen-containing compound include melamine cyanurate and melamine isocyanurate.

Melamine cyanurate and melamine isocyanurate are organic salts of the acidic compound, namely, cyanuric acid or isocyanuric acid, with the basic compound melamine. In the salts, the acidic compound: basic compound molar ratio is usually 1:1. The salts may be produced by a known method. For example, a mixture of melamine and cyanuric acid or isocyanuric acid is suspended in water and the compounds are mixed to form a salt; the slurry is then filtered; and the residue is dried to give the salt as a powder.

Examples of the salts of nitrogen-containing compounds further include salts of melamine, melam, and melem as the basic compounds with polyphosphoric acid. Exemplary commercial products include “PHOSMEL-200 (average particle diameter: 5 μm or less)” and “PHOSMEL-200 FINE (average particle diameter: 3 μm or less)” (manufactured by NISSAN CHEMICAL CORPORATION) in which the proportions of the basic compounds are 43 to 57% melamine, 31 to 46% melam, and 8 to 17% melem. The salts of nitrogen-containing compounds may be used singly, or two or more may be used in combination.

Specifically, for example, the nitrogen-containing compound component is preferably at least one kind selected from the group consisting of guanidine carbonate, melamine, melamine cyanurate, and salts of melamine, melam, and melem with polyphosphoric acid, more preferably at least one kind selected from the group consisting of guanidine carbonate and melamine, and still more preferably melamine.

### <Aromatic Compounds Having a Phenolic Hydroxyl Group>

The mixture to be fired bodies preferably comprises an aromatic compound having a phenolic hydroxyl group.

Examples of the aromatic compounds having a phenolic hydroxyl group include monocyclic or fused polycyclic aromatic compounds having one or more phenolic hydroxyl groups.

Particular examples include monohydric to hexahydric phenols that are monocyclic aromatic compounds having 1 to 6 phenolic hydroxyl groups.

Exemplary phenols that are monocyclic aromatic compounds and have one phenolic hydroxyl group include phenol, ethylphenol, p-t-butylphenol, o-cresol, m-cresol, p-cresol, 2,3-xylenol, 2,4-xylenol, 2,5-xylenol, 2,6-xylenol, thymol, mesitol, pseudocumenol, 2,6-di-t-butyl-p-cresol, pentamethylphenol, o-hydroxystyrene, m-hydroxystyrene, p-hydroxystyrene, chavicol, o-allylphenol, anol, diethylstilbestrol, p-(methylthio) phenol, o-aminophenol, m-aminophenol, p-aminophenol, o-(methylamino) phenol, m-(methylamino) phenol, p-(methylamino) phenol, m-(dimethylamino) phenol, o-anilinophenol, m-anilinophenol, p-anilinophenol, 2-amino-p-cresol, 3-amino-o-cresol, 3-amino-p-cresol, 4-amino-o-cresol, 4-amino-p-cresol, 5-amino-o-cresol, 6-amino-m-cresol, 2,4-diaminophenol, and 2,4,6-triaminophenol.

Exemplary phenols that are monocyclic aromatic compounds and have two phenolic hydroxyl groups include catechol, resorcinol, hydroquinone, 3,4-toluenediol, 2,5-toluenediol, 3,5-toluenediol, 2,4-toluenediol, urushiol, p-xylene-2,6-diol, m-xylene-4,6-diol, p-xylene-2,5-diol, and 2-isopropyl-5-methylhydroquinone.

Exemplary phenols that are monocyclic aromatic compounds and have three phenolic hydroxyl groups include pyrogallol, 1,2,4-benzenetriol, phloroglucinol, 2-methylphloroglucinol, m-xylene-2,4,6-triol, and 2,4,6-trimethylphloroglucinol.

Exemplary phenols that are monocyclic aromatic compounds and have four phenolic hydroxyl groups include 1,2,3,5-benzenetetraol and 1,2,4,5-benzenetetraol.

Exemplary phenols that are monocyclic aromatic compounds and have six phenolic hydroxyl groups include hexahydroxybenzene.

Among the monocyclic aromatic compounds having a phenolic hydroxyl group, monocyclic aromatic compounds having 3 to 6 phenolic hydroxyl groups are preferable. The phenols that is the monocyclic aromatic compounds having three phenolic hydroxyl groups are more preferably. Phloroglucinol represented by formula (I) below is still more preferable.

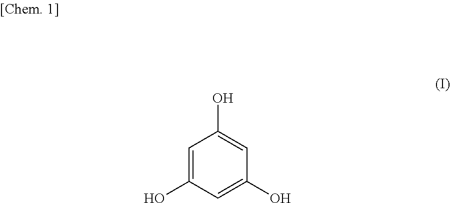

Examples of the fused polycyclic aromatic compounds include naphthalene, azulene, heptalene, biphenylene, acenaphthylene, fluorene, phenalene, phenanthrene, anthracene, aceanthrylene, triphenylene, pyrene, chrysene, tetracene, perylene, pentacene, picene, and coronene. Naphthalene, anthracene, and triphenylene are preferable.

Examples of the fused polycyclic aromatic compounds having a phenolic hydroxyl group include 1,2-dihydroxynaphthalene, 1,3-dihydroxynaphthalene, 1,4-dihydroxynaphthalene, 1,5-dihydroxynaphthalene, 1,6-dihydroxynaphthalene, 2,3-dihydroxynaphthalene, 2,4-dihydroxynaphthalene, 2,5-dihydroxynaphthalene, 2,6-dihydroxynaphthalene, 1,3,8-trihydroxynaphthalene, 9,10-anthracene, ellagic acid, and 2,3,6,7,10,11-hexahydroxytriphenylene. Preferred examples include 2,6-dihydroxynaphthalene, 1,3,8-trihydroxynaphthalene, 9,10-anthracene, ellagic acid, and 2,3,6,7,10,11-hexahydroxytriphenylene. More preferred examples include ellagic acid represented by formula (II) below and 2,3,6,7,10,11-hexahydroxytriphenylene represented by formula (III) below.

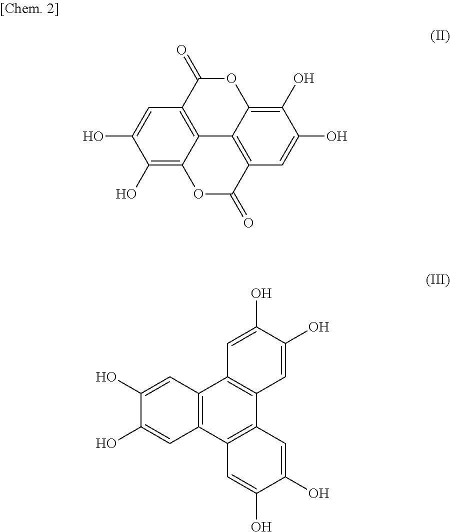 [SMILES: O=c1oc2c(O)c(O)cc3c(=O)oc4c(O)c(O)cc1c4c23 ; Oc1cc2c3cc(O)c(O)cc3c3cc(O)c(O)cc3c2cc1O]

The aromatic compounds having a phenolic hydroxyl group may be used singly, or two or more may be used in combination.

The aromatic compound having a phenolic hydroxyl group, whether monocyclic or fused polycyclic, preferably has 3 or more phenolic hydroxyl groups, and more preferably has 3 to 6 phenolic hydroxyl groups because such a compound can form a three-dimensional polymer as will be described later.

### <Rare Earth Metal Compounds>

The mixture to be fired bodies preferably comprises a rare earth metal compound.

The metal in the rare earth metal compound is preferably at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium.

Examples of the rare earth metal compounds include:
CeBr₃, CeCl₃·7H₂O, CeF₃, CeF₄, CeI₃,
DyBr₃, DyBr₃·xH₂O, DyCl₃, DyCl₃·6H₂O,
DyF₃, DyI₃,
ErBr₃·xH₂O, ErCl₃, ErCl₃·6H₂O, ErF₃, ErI₃,
EuBr₃·xH₂O, EuCl₂, EuCl₃, EuCl₃·6H₂O,
EuF₃, EuI₂,
GdBr₃, GdCl₃, GdCl₃·6H₂O, GdCl₃·xH₂O,
GdF₃, GdI₃,
HoBr₃, HoBr₃·xH₂O, HoCl₃, HoCl₃·6H₂O,
HoF₃,
LaBr₃·xH₂O, LaCl₃·7H₂O, LaCl₃·xH₂O,
LaF₃, LaI₃,
LuBr₃, LuCl₃, LuCl₃·6H₂O, LuF₃, LuI₃,
NdBr₃, NdCl₃, NdCl₃·6H₂O, NdF₃, NdI₂,
NdI₃,
PrBr₃, PrBr₃·xH₂O, PrCl₃,
SmBr₃, SmCl₃, SmCl₃·6H₂O, SmI₂, SmI₃,
ScBr₃, ScCl₃, ScCl₃·6H₂O, ScF₃, ScI₃,
TbBr₃, TbCl₃, TbCl₃·6H₂O, TbF₃, TbI₃,
TmBr₃, TmCl₃, TmCl₃·6H₂O, TmF₃,
YbBr₃, YbBr₃·xH₂O, YbCl₃, YbCl₃·6H₂O,
YbF₃, YbI₂,
YCl₃, YCl₃·6H₂O, YF₃, YI₃,
Ce(NH₄)₂(NO₃)₆, Ce(NO₃)₃·6H₂O,
Dy(NH₄)₂(NO₃)₆, Er(NO₃)₃·5H₂O,
Er(NO₃)₃·xH₂O,
Gd(NO₃)₃·6H₂O, Ho(NO₃)₃·5H₂O,
La(NO₃)₃·6H₂O, La(NO₃)₃·xH₂O,
Lu(NO₃)₃·xH₂O,
Nd(NO₃)₃·6H₂O, Pr(NO₃)₃·6H₂O,
Sm(NO₃)₃·6H₂O, Tb(NO₃)₃·5H₂O,
Tb(NO₃)₃·6H₂O,
Yb(NO₃)₃·5H₂O,
Ce(CH₃CO₂)₃·xH₂O, Eu(CH₃CO₂)₃·xH₂O,
Gd(CH₃CO₂)₃·xH₂O, La(CH₃CO₂)₃·xH₂O,
Tb(CH₃CO₂)₃·xH₂O, Yb(C₂H₃O₂)₃·4H₂O,
CeO₂, Dy₂O₃, Er₂O₃, Eu₂O₃, Gd₂O₃, Ho₂O₃,
La₂O₃,
Lu₂O₃, Nd₂O₃,
Pr₂O₃, Pr₆O₁₁, Sm₂O₃, Sc₂O₃, Tb₂O₃, Tb₄O₇,
Tm₂O₃,
Yb₂O₃, Y₂O₃,
AlCeO₃, (CeO₂)(ZrO₂), as well as rare earth metal alkoxide compounds and rare earth metal acetylacetonate compounds. These may be used singly, or two or more may be used in combination.

Specific examples of the rare earth metal alkoxide compounds include rare earth metal triisopropoxides. Specific examples of the rare earth metal triisopropoxides include scandium triisopropoxide, yttrium triisopropoxide, lanthanum triisopropoxide, cerium triisopropoxide, praseodymium triisopropoxide, neodymium triisopropoxide, promethium triisopropoxide, samarium triisopropoxide, europium triisopropoxide, gadolinium triisopropoxide, terbium triisopropoxide, dysprosium triisopropoxide, holmium triisopropoxide, erbium triisopropoxide, thulium triisopropoxide, ytterbium triisopropoxide, and lutetium triisopropoxide.

Specific examples of the rare earth metal acetylacetonate compounds include tris(acetylacetonato) scandium (III), tris(acetylacetonato) yttrium, tris(acetylacetonato) lanthanum (III), tris(acetylacetonato) cerium (III), tris(acetylacetonato) neodymium (III), tris(acetylacetonato) promethium (III), tris(acetylacetonato) samarium (III), tris(acetylacetonato) europium (III), tris(acetylacetonato) gadolinium (III), tris(acetylacetonato) terbium (III), tris(acetylacetonato) dysprosium (III), tris(acetylacetonato) holmium (III), tris(acetylacetonato) erbium (III), tris(acetylacetonato) thulium (III), tris(acetylacetonato) ytterbium (III), and tris(acetylacetonato) lutetium (III). These may be in the form of hydrates.

The rare earth metal compound is preferably at least one kind selected from the group consisting of.
CeBr₃, CeCl₃·7H₂O, CeF₃, CeF₄, CeI₃,
EuBr₃·xH₂O, EuCl₂, EuCl₃, EuCl₃·6H₂O,
EuF₃, EuI₂,
NdBr₃, NdCl₃, NdCl₃·6H₂O, NdF₃, NdI₂,
NdI₃,
SmBr₃, SmCl₃, SmCl₃·6H₂O, SmI₂, SmI₃,
Ce(NH₄)₂(NO₃)₆, Ce(NO₃)₃·6H₂O,
Nd(NO₃)₃·6H₂O,
Ce(CH₃CO₂)₃·xH₂O, Ce(C₅H₇O₂)₃·xH₂O,
Eu(CH₃CO₂)₃·xH₂O,
CeO₂, Eu₂O₃, Nd₂O₃,
Sm₂O₃, Sc₂O₃, (CeO₂)(ZrO₂), and samarium triisopropoxide, and is more preferably at least one kind selected from the group consisting of:
CeBr₃, CeCl₃·7H₂O, CeF₃, CeF₄, CeI₃, EuI₂, NdI₂, NdI₃, SmBr₃, SmCl₃, SmCl₃·6H₂O,
SmI₂, SmI₃,
Ce(NH₄)₂(NO₃)₆, Ce(NO₃)₃·6H₂O,
Ce(CH₃CO₂)₃·xH₂O, Ce(C₅H₇O₂)₃·xH₂O, Sm₂O₃, and samarium triisopropoxide.

The rare earth metal compound supplies rare earth metal ions and in the fired body, the rare earth metal ions are preferably bonded to monovalent anions resulting from the formal deprotonation of substituents or structures on the surface and carbon vacancies derived from graphene oxide, specifically, at least one kind of substituents or structures selected from the group consisting of hydroxyl groups, carboxyl groups, carbonyl groups, formyl groups, carboxylic acid anhydride structures, chromene structures, lactone structures, ester structures, and ether structures. More preferably, the rare earth metal ions are bonded to monovalent anions resulting from the formal deprotonation of at least one kind of substituents or structures selected from the group consisting of hydroxyl groups, carboxyl groups, lactone structures, and ester structures.

The manner of bonding is selected from the group consisting of hydrogen bonding and coordination bonding. Hydrogen bonding is probably mediated by water molecules, and excellent stability is obtained by the shift to coordination bonding. Thus, the manner of bonding is preferably coordination bonding.

In the fired body, the rare earth metal ions are preferably bonded to monovalent anions resulting from the formal deprotonation of hydroxyl groups in the fired body derived from graphene oxide. The rare earth metal ions are more preferably bonded in such a manner that the rare earth metal ion is sandwiched between two hydroxyl-derived monovalent anions to form a chelate structure.

In the fired body, the rare earth metal ion and graphene oxide preferably have a structure represented by formula (X) below.

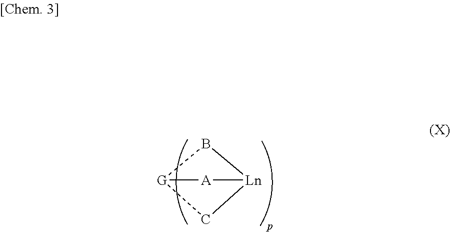

In formula (X), G denotes graphene optionally having at least one kind selected from the group consisting of hydroxyl groups, carboxyl groups, carbonyl groups, formyl groups, oxysulfonic acid groups, carboxylic acid anhydride structures, chromene structures, lactone structures, ester structures, and ether structures. It is preferable that G is graphene having at least one kind selected from the group consisting of hydroxyl groups and carboxyl groups.

The letter A is a group selected from —O— and —COO—. When the structure contains a plurality of A, the groups A may be the same as or different from one another. It is preferable that A is —O—.

The letter B is a group selected from —O— and —COO or is a hydroxyl group. When the structure contains a plurality of B, the groups B may be the same as or different from one another. It is preferable that B be —O— or a hydroxyl group.

The letter C is a group selected from —O— and —COO— or is a hydroxyl group. When the structure contains a plurality of C, the groups C may be the same as or different from one another. It is preferable that C be —O— or a hydroxyl group.

When B and C are each a group selected from —O— and —COO—, these groups are each independently bonded to G to which A is bonded or are each independently bonded to G different from G to which A is bonded.

When B and C are hydroxyl groups, they are each independently bonded only to Ln.

The manner of bonding between A and Ln, bonding between B and Ln, and bonding between C and Ln may be hydrogen bonding or coordination bonding. For the reason that the stability is increased, the manner of bonding is preferably such that G and Ln together with at least two kinds selected from the group consisting of A, B, and C form one or more cyclic structures, namely, a chelate structure.

Ln denotes a rare earth metal ion, specifically, at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium. Ln is preferably at least one kind selected from the group consisting of scandium, yttrium, lanthanum, cerium, praseodymium, neodymium, samarium, europium, gadolinium, and ytterbium, and is more preferably at least one kind metal selected from the group consisting of scandium, yttrium, lanthanum, cerium, samarium, europium, and ytterbium.

The letter p is an integer of 1 or greater.

For example, the compound represented by formula (X) may be the compound represented by formula (Xa), although not particularly limited thereto.

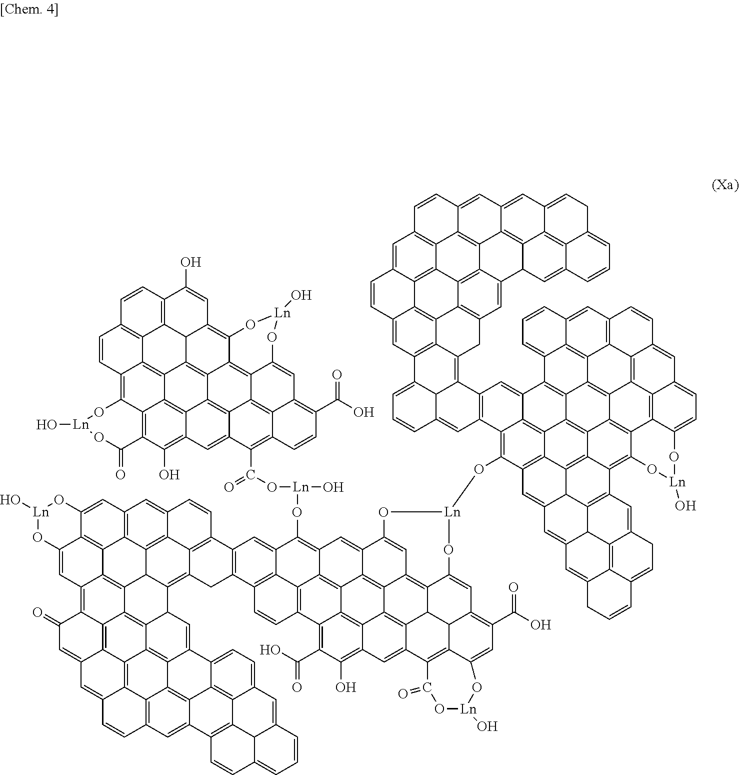

The ingredients for the fired body include graphene oxide and the nitrogen-containing compound component, optionally together with at least one kind selected from the group consisting of the aromatic compound having a phenolic hydroxyl group and the rare earth metal compound. The amounts of the components added in the mixture are not particularly limited. In 100 mass % of the mixture, the mass of graphene oxide is taken as a solid content and is preferably 1 to 99 mass %, more preferably 20 to 70 mass %; and the mass of the nitrogen-containing compound component is preferably 0.5 to 99 mass %, more preferably 10 to 60 mass %. When graphene oxide is in the form of a dispersion, the amount in which graphene oxide is added excludes the amount of the dispersion medium. The amount of the aromatic compound having a phenolic hydroxyl group is preferably 0.5 to 99 mass %, more preferably 10 to 60 mass %, and the amount of the rare earth metal compound is preferably 0.5 to 99 mass %, more preferably 10 to 60 mass %. The above ranges of the blending amounts advantageously offer improvements in ion conductivity, electron conductivity, water transport, and gas permeability in catalyst layers.

### <Methods for Producing the Fired Bodies>

The fired body is obtained by firing a mixture that includes graphene oxide, the nitrogen-containing compound component, and optionally at least one kind selected from the group consisting of the aromatic compound having a phenolic hydroxyl group and the rare earth metal compound.

The firing temperature may be any temperature that can polymerize, carbonize, or pyrolyzing the nitrogen-containing compound component, the optional aromatic compound having a phenolic hydroxyl group, and the optional rare earth metal compound. The firing temperature is preferably 150 to 1200° C., more preferably 200 to 800° C., and still more preferably 250 to 600° C. Firing is performed at the firing temperature preferably for 1 to 10 hours, more preferably for 1 to 5 hours. Firing may be performed in air or under an inert gas. Examples of the inert gases include nitrogen and argon.

The fired body may be preferably produced by production method A in which graphene oxide and the nitrogen-containing compound component are mixed beforehand, or by production method B in which all the components are mixed at once.

Production method A for producing the fired body includes: (step A1) a step of mixing graphene oxide and the nitrogen-containing compound component to obtain a mixture of graphene oxide and the nitrogen-containing compound component;
(step A2) a step of mixing the mixture from step A1 with at least one kind optional component selected from the group consisting of the aromatic compound having a phenolic hydroxyl group and the rare earth metal compound to obtain a final mixture; and
(step A3) a step of firing the mixture obtained in step A1 or the final mixture obtained in step A2.

(Step A2) is an optional step.

In (step A1), for example, the nitrogen-containing compound component may be dispersed in an aqueous graphene oxide dispersion, and the dispersion may be further stirred or crushed with a homogenizer or the like. In the mixture obtained by this operation, the nitrogen-containing compound component is probably inserted between layers of graphene oxide. In step A1, the dispersion medium may be distilled off. The present inventors believe that when the nitrogen-containing compound component has been inserted between layers of graphene oxide, the nitrogen-containing compound can be prevented from being gasified directly during firing without reaction of the functional groups in the target fired body. Thus, the nitrogen-containing compound can advantageously form the fired body efficiently.

For example, the mixture of graphene oxide and the nitrogen-containing compound component may be produced by the method described in Japanese Patent Application No. 2021-161494 that is patent literature or in Journal of Applied Polymer Science, 2021, Vol. 138, No. 8, p. e49866 that is non patent literature.

The present inventors assume that layered graphene oxide is partly disassembled when treated with a homogenizer or irradiated with ultrasonic waves or the like, but the resultant structure is unstable and thus returns back to the layered structure while incorporating the nitrogen-containing compound present in the dispersion.

In (step A2), the mixture from step A1 and at least one kind optional component selected from the aromatic compound having a phenolic hydroxyl group and the rare earth metal compound are mixed together by being dispersed in a dispersion medium with use of a homogenizer, ultrasonic waves, or the like.

In (step A3), the mixture obtained in step A1 or the final mixture obtained in step A2 is fired at the firing temperature by the firing method described hereinabove.

When the aromatic compound having a phenolic hydroxyl group and/or the rare earth metal compound is added, production method B may be adopted to produce the fired body. Production method B for producing the fired body includes:
(step B1) a step of mixing graphene oxide, the nitrogen-containing compound component, and at least one kind optional component selected from the group consisting of the aromatic compound having a phenolic hydroxyl group and the rare earth metal compound to obtain a final mixture, and
(step B2) a step of firing the final mixture obtained in step B1.

In (step B1), graphene oxide, the nitrogen-containing compound component, the optional aromatic compound having a phenolic hydroxyl group, and the optional rare earth metal compound are mixed together by being dispersed in a dispersion medium with use of a homogenizer, ultrasonic waves, or the like.

In (step B2), the final mixture obtained in step B1 is fired at the firing temperature by the firing method described hereinabove.

### <Structures of the Fired Bodies>

In the fired body, the starting nitrogen-containing compound component and the starting aromatic compound having a phenolic hydroxyl group may be included in the structure of starting graphene oxide or the structure of reduced graphene oxide having hydrogen atoms in place of oxygen functional group.

Alternatively, at least part of the starting nitrogen-containing compound component and at least part of the starting aromatic compound having a phenolic hydroxyl group may be included in the fired body as respective three-dimensional polymers. It is probable that in some cases, the starting nitrogen-containing compound component and the starting aromatic compound having a phenolic hydroxyl group undergo thermal condensation reaction and thermal polymerization reaction during firing to form a three-dimensional polymer of the aromatic compound having a phenolic hydroxyl group, and a three-dimensional polymer of the nitrogen-containing compound constituting the starting nitrogen-containing compound component. When the thermal condensation reaction and the thermal polymerization reaction occur in three dimensions, the starting aromatic compound having a phenolic hydroxyl group has 3 or more phenolic hydroxyl groups and the nitrogen-containing compound constituting the starting nitrogen-containing compound component has 3 or more functional groups.

When phloroglucinol represented by formula (I) below is used as the starting ingredient, the three-dimensional polymer of the aromatic compound having a phenolic hydroxyl group is represented by, for example, formula (a) below.

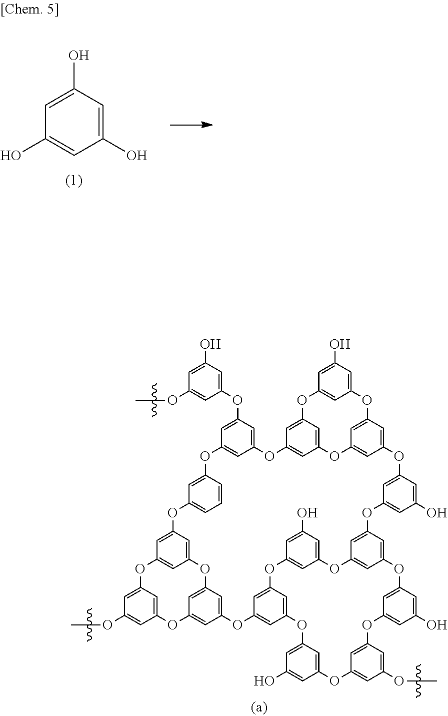 [SMILES: Oc1cc(O)cc(O)c1 ; *Oc1cc(O)cc(Oc2cc3cc(c2)Oc2cc4cc(c2)Oc2cc(cc(c2)Oc2cc(O)cc(c2)O4)Oc2cc(O)cc(c2)Oc2cc4cc(c2)Oc2cc(O)cc(c2)Oc2cc(cc(c2)Oc2cc5cc(c2)Oc2cc(cc(c2)Oc2cc(O*)cc(c2)O5)Oc2cccc(c2)O3)Oc2cc(O)cc(c2)Oc2cc(O*)cc(c2)Oc2cc(O)cc(c2)O4)c1]

When the mixture that is fired includes the rare earth metal compound, the aromatic compound having a phenolic hydroxyl group, graphene oxide, and the nitrogen-containing compound component, and phloroglucinol represented by formula (I) is used as the starting ingredient, the three-dimensional polymer of the aromatic compound having a phenolic hydroxyl group is represented by, for example, formula (b) below.

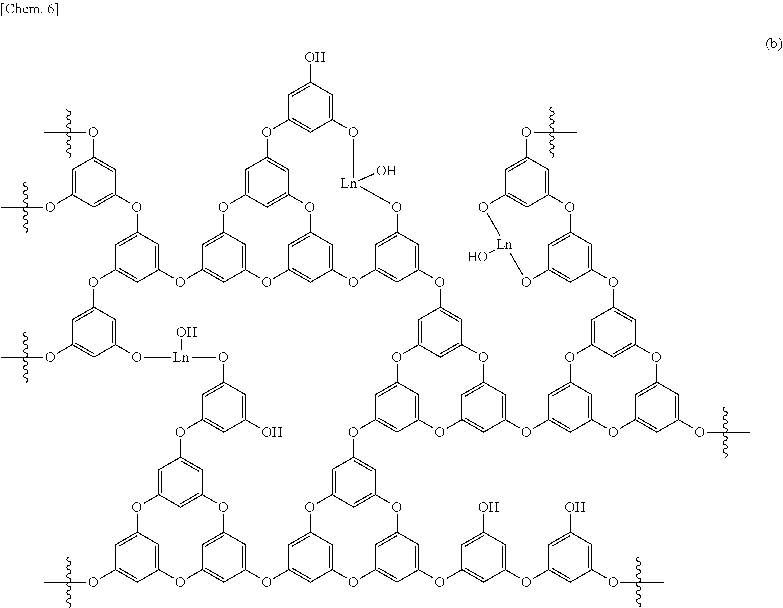

For example, the nitrogen-containing compound forms a three-dimensional polymer in the following manner. Firing melamine (i) as the starting ingredient, it by removing ammonia forms melams represented by formula (ii) below, melem represented by formula (iii), the compounds represented by formula (iv) or formula (v) below, and melons represented by formula (vi), formula (vii), or formula (viii) below, which is deammoniated condensation product.

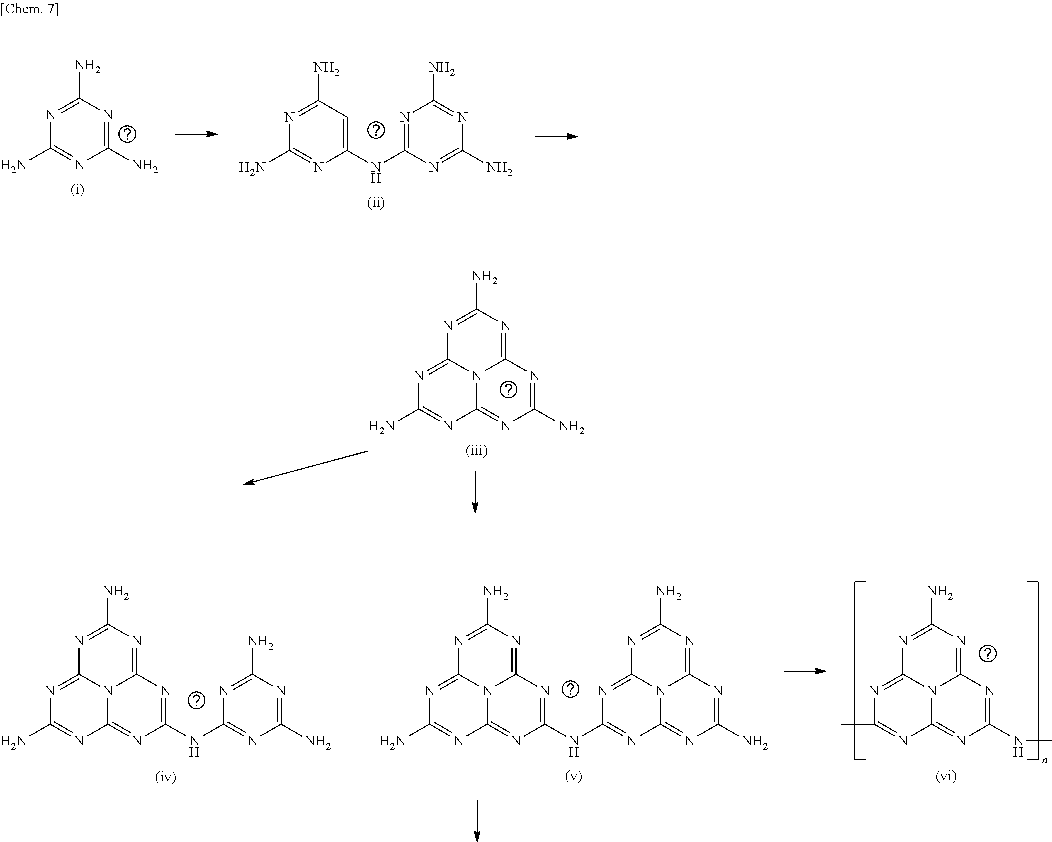

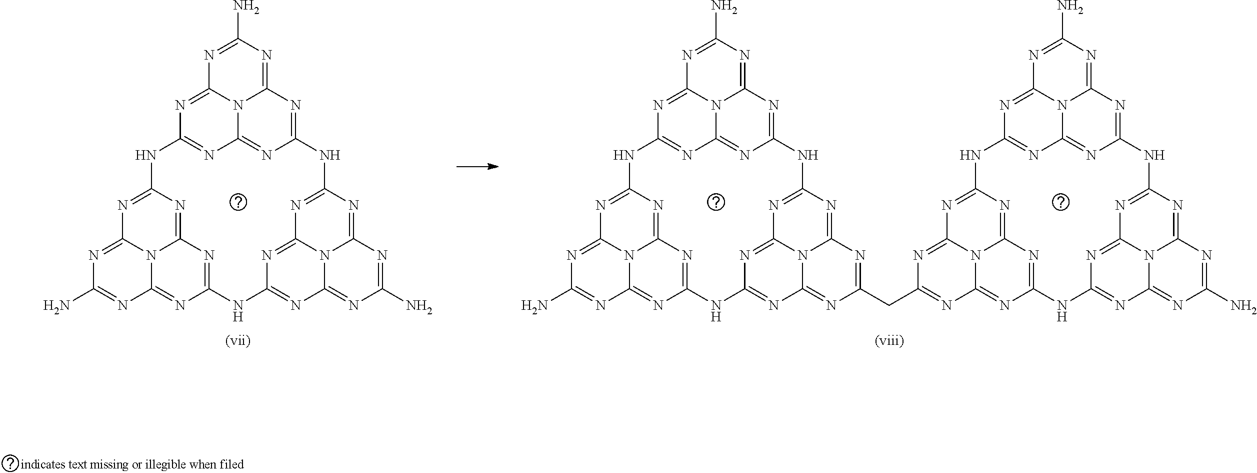 [SMILES: NC1=NC2=NC3=NC4=NC(=NC(=N1)N24)NC1=NC2=NC(=NC4=NC(N)=NC(=N1)N42)NC1=NC2=NC(=NC4=NC(N)=NC(=N1)N42)N3 ; NC1=NC2=NC3=NC4=NC(=NC(=N1)N24)NC1=NC2=NC(=NC4=NC(N)=NC(=N1)N42)NC1=NC2=NC(=NC4=NC(CC5=NC6=NC7=NC8=NC(=NC(=N5)N68)NC5=NC6=NC(=NC8=NC(N)=NC(=N5)N86)NC5=NC6=NC(=NC8=NC(N)=NC(=N5)N86)N7)=NC(=N1)N42)N3]

The three-dimensional polymer of the nitrogen-containing compound may be a continuation of a large number of structures including the structures (i) to (viii) and is represented by, for example, formula (ix) below. By further proceeding the polymerization reaction, the structure forms graphitic carbon nitride g-C₃N₄ represented by formula (x) below and becomes layered.

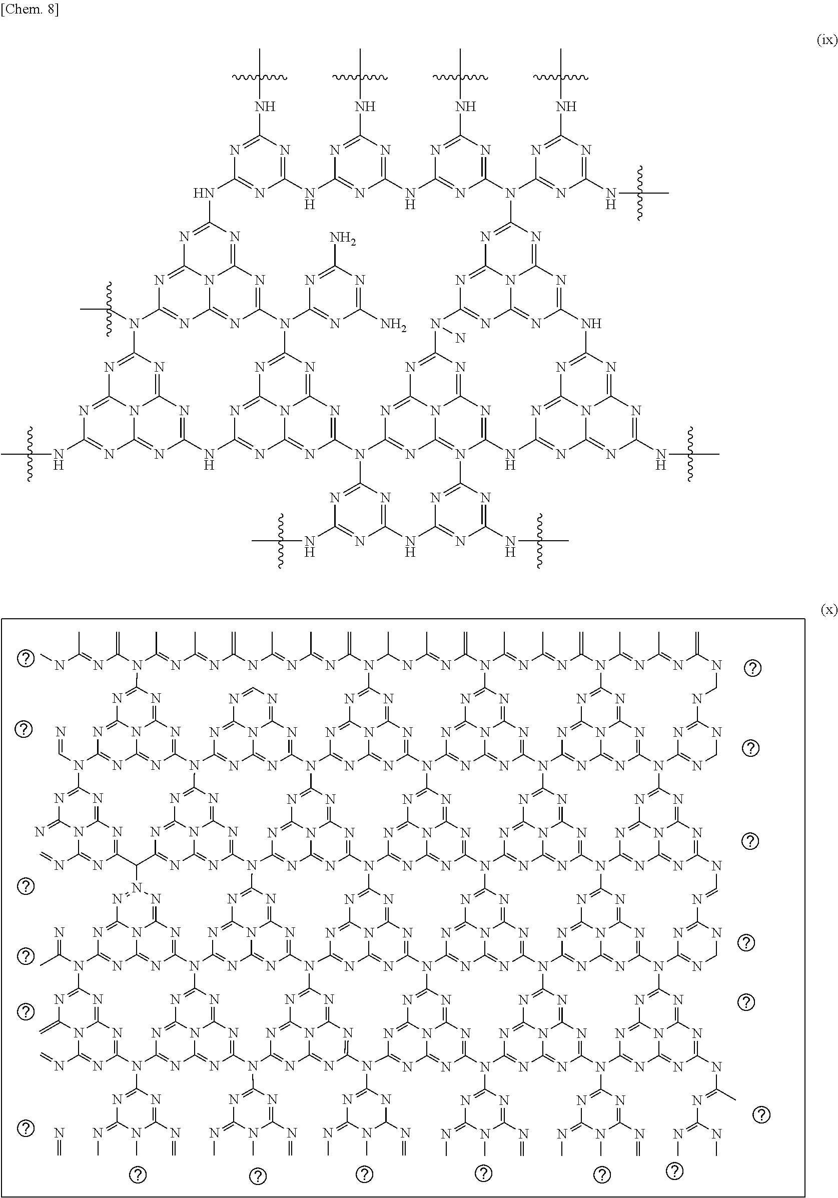

For the structure of graphitic carbon nitride, reference may be made to the 10 following non patent literature.
(Non Patent Literature A) Journal of the Society of Chemical Industry, Japan, 1963, Vol. 66, No. 6, pp. 804-809
(Non Patent Literature B) Chem. Eur. J., 2007, vol. 13, pp. 4969-4980

Whether the starting nitrogen-containing compound component and the starting aromatic compound having a phenolic hydroxyl group maintain their mother structures or are contained as the three-dimensional polymers in the fired body considered to depend on conditions, such as firing temperature and firing time, and the structures of the starting nitrogen-containing compound component and the starting aromatic compound having a phenolic hydroxyl group.

### <Use Applications of the Fired Bodies>

In a polymer electrolyte fuel cell, the fired body may be used as an electrolyte or a catalyst carrier in a catalyst layer or may be used in a solid electrolyte membrane, and can improve power generation characteristics of the fuel cell. Furthermore, the fired body may be used in a catalyst layer as a material for an electrode catalyst for water electrolysis or the like and can improve power generation characteristics of the fuel cell and the voltage balance performance in water electrolysis. An example in which the fired body is used in a fuel cell will be described below.

### <<Polymer Electrolyte Fuel Cells>>

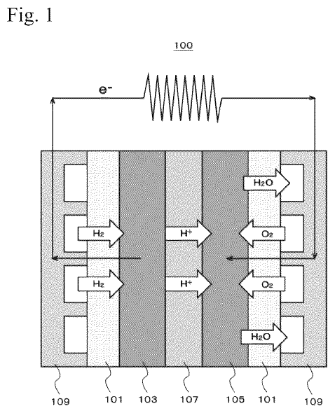

FIG. 1 is a sectional view schematically illustrating a configuration of a polymer electrolyte fuel cell (hereinafter, also written as the “fuel cell”). A polymer electrolyte fuel cell 100 has an anode catalyst layer 103, a cathode catalyst layer 105, and a solid electrolyte membrane 107 sandwiched between the catalyst layers. Each of the catalyst layers has a gas diffusion layer (hereinafter, abbreviated as the “GDL”) 101 as an outside layer. This configuration is written as the membrane-electrode assembly (hereinafter, abbreviated as “MEA”). In the fuel cell, this MEA is usually sandwiched between separators 109.

At least one of the anode catalyst layer 103 or the cathode catalyst layer 105 includes the fired body described hereinabove. Furthermore, the solid electrolyte membrane 107 may also include the fired body. In order to suppress an overvoltage rise at the time of high-current driving, it is preferable that the fired body be used in at least the cathode catalyst layer 105.

The fired body has proton conductivity, electron conductivity, water transport, and gas permeability, and also has a function to support a catalyst owing to its structure. Thus, the fired body in a fuel cell may be used as a catalyst carrier, an electrolyte, or both in a catalyst layer and/or as an electrolyte in a solid electrolyte membrane.

The main functions of the fired body include the specific surface area originally offered by graphene oxide that is the base of the fired body. In addition, proton-donating effects are produced by the phenolic hydroxyl groups in the fired body derived from the aromatic compound having a phenolic hydroxyl group. The carbon material after firing suppresses aggregation, and consequently the dispersion stability of a catalyst ink is effectively improved. The solid catalyst supporting performance is improved Water transport function is offered by the adsorption and desorption of water. Protons are effectively donated by, for example, the triazine skeleton or the melon skeleton in the three-dimensional polymer of the nitrogen-containing compound. The carbon material that is the base can effectively adsorb reactive gases to the surface thereof. The solid catalyst supporting performance is improved. Furthermore, pores present in graphene oxide itself probably have a gas diffusion function.

The anode catalyst layer 103 and the cathode catalyst layer 105 are each obtained by preparing a catalyst ink that is a composition including the fired body and a metal catalyst, and applying the catalyst ink to a target substrate, followed by drying. That is, the anode catalyst layer 103 and the cathode catalyst layer 105 each have a composition that contains a metal catalyst and at least one kind selected from the group consisting of the fired bodies described hereinabove.

Preferably, the fired body is used as one kind of the electrolytes and one kind of the catalysts carrier at the same time. The fired body serving both as an electrolyte and as a catalyst carrier can have proton conductivity that a conventional catalyst carrier doesn't have, as a result improvement of electrical characteristics etc. of fuel cells is expected.

A catalyst supported on a catalyst carrier is called an electrode catalyst. In the present description, the anode catalyst layer 103 and the cathode catalyst layer 105 are sometimes written simply as the catalyst layers.

The metal catalyst contained in the catalyst ink may be any of known metal catalysts without particular limitation. The main function of the metal catalysts used in the anode catalyst layer 103 and the cathode catalyst layer 105 is to induce electrochemical reactions. Examples of the metal catalysts include platinum-containing catalysts, such as platinum, alloys of platinum with other metals, and core-shell particles having platinum as the shell; and other metal catalysts. The metal catalysts may be used singly, or two or more may be used in combination. Among those described above, platinum-containing catalysts are preferable from the point of view of catalytic activity.

In the alloys of platinum with other metals, the metals that constitute the alloys with platinum are not particularly limited and may be any metals other than platinum. Examples include boron, magnesium, aluminum, silicon, calcium, scandium, titanium, vanadium, chromium, manganese, iron, cobalt, nickel, copper, zinc, gallium, germanium, strontium, yttrium, zirconium, niobium, molybdenum, technetium, ruthenium, rhodium, palladium, silver, indium, tin, antimony, barium, hafnium, tantalum, tungsten, rhenium, osmium, iridium, gold, lead, bismuth, lanthanum, and cerium. These may be used singly, or two or more may be used in combination.

In the core-shell particles having platinum as the shell, the core is made of a metal other than platinum and the shell is platinum. The metal used as the core is not particularly limited and may be any metal other than platinum. Examples include nickel, copper, palladium, silver, gold, iridium, titanium, iron, cobalt, ruthenium, osmium, chromium, molybdenum, and tungsten. These may be used singly, or two or more may be used in combination.

While the platinum-containing catalyst is preferable, the catalyst is not limited thereto. Other metal catalysts may also be used, with examples including noble metals, such as gold, silver, ruthenium, rhodium, palladium, osmium, and iridium, base metals, such as iron, nickel, manganese, cobalt, chromium, copper, zinc, molybdenum, tungsten, germanium, and tin, alloys of these noble metals and base metals, and compounds, such as metal oxides and metal complexes. These may be used singly, or two or more may be used in combination.

The composition used as the catalyst ink may include, in addition to the metal catalyst and the fired body, a catalyst carrier other than the fired body, an electrolyte other than the fired body, a binder, and a solvent. Similarly to the metal catalyst and the fired body, these components except the solvent are contained in at least one of the anode catalyst layer 103 or the cathode catalyst layer 105.

Examples of the catalyst carriers other than the fired body that may be contained in the composition used as the catalyst ink include carbon materials, for example, carbon blacks, such as channel black, furnace black, and thermal black, activated carbons obtained by carbonizing and activating various carbon-containing materials, cokes, natural graphites, artificial graphites, and graphitized carbons. Among those described above, carbon blacks are preferable as the catalyst carriers other than the fired body because they have high specific surface area and excellent electron conductivity. The main functions of the catalyst carrier include electron conduction. The main functions of the catalyst carrier also include gas and water transport through the pores present in the catalyst carrier.

In order to suppress the decrease in electron conductivity in the electrode catalyst, a binder that binds the catalyst carrier particles together may be used in the catalyst layer. Examples of the binders include fluorinated sulfonic acid polymers, such as polytetrafluoroethylene (PTFE), polyvinylidene fluoride (PVDF), ethylene-propylene-diene copolymer (EPDM), Nafion (registered trademark, manufactured by DuPont), Aquivion (registered trademark, manufactured by Solvay), FLEMION (registered trademark, manufactured by AGC Inc.), and Aciplex (registered trademark, manufactured by Asahi Kasei Corporation) Among the binders, those that also function as polymer electrolytes, such as Nafion, are regarded as polymer electrolytes when contained in the catalyst composition.

Examples of the electrolytes other than the fired body that may be contained in the composition used as the catalyst ink include fluorinated sulfonic acid polymers, such as Nafion (registered trademark, manufactured by DuPont), Aquivion (registered trademark, manufactured by Solvay), Flemion (registered trademark, manufactured by AGC Inc.), and Aciplex (registered trademark, manufactured by Asahi Kasei Corporation), hydrocarbon-based sulfonic acid polymers, and partially fluorinated hydrocarbon-based sulfonic acid polymers. Preferred electrolytes other than the fired body are fluorinated sulfonic acid polymers, such as Nafion (registered trademark, manufactured by DuPont), Aquivion (registered trademark, manufactured by Solvay), Flemion (registered trademark, manufactured by AGC Inc.), and Aciplex (registered trademark, manufactured by Asahi Kasei Corporation). Nafion (registered trademark, manufactured by DuPont) is more preferable. The electrolyte that is used may be the fired body alone or may be a mixture of the fired body and the electrolyte described above. The main function of the electrolyte in the catalyst layer is to conduct protons, and the fuel gas permeability and water transport are further required at the same time. Thus, the electrolyte in the composition used as the catalyst ink preferably includes the fired body and a fluorinated sulfonic acid polymer, such as Nafion, from the point of view of voltage characteristics in a high-current region. In the catalyst layer containing the fired body, any materials for use in solid electrolyte membranes, specifically, fluorinated sulfonic acid polymers, hydrocarbon-based sulfonic acid polymers, and partially fluorinated hydrocarbon-based sulfonic acid polymers may be used as catalyst layer materials. Fluorinated sulfonic acid polymers and partially fluorinated hydrocarbon-based sulfonic acid polymers are preferably used.

Examples of the solvents used in the composition as the catalyst ink include water, methanol, ethanol, 1-propanol, 2-propanol, 1-butanol, 2-butanol, isobutyl alcohol, tert-butyl alcohol, pentanol, dimethyl sulfoxide, and N,N-dimethylformamide. Preferred solvents are water, methanol, ethanol, 1-propanol, 2-propanol, 1-butanol, 2-butanol, and isobutyl alcohol. Two or more of the above solvents may be used as a mixture. The solvents used in the catalyst ink are more preferably water, ethanol, 1-propanol, and 2-propanol for the reasons that the ink is free from reaggregation and is easy to apply, and that the solvent will not remain in the catalyst layer.

The content of each component in the composition used as the catalyst ink is controlled appropriately in accordance with the purpose. In 100 mass % of the solid content in the catalyst ink except the mass of the solvent, the metal catalyst preferably represents 14 to 44 mass %, more preferably 20 to 34 mass %, the fired body preferably represents 1 to 25 mass %, more preferably 1.5 to 20 mass %, an additional electrolyte preferably represents 20 to 45 mass %, more preferably 25 to 40 mass %, an additional catalyst carrier preferably represents 20 to 55 mass %, more preferably 25 to 45 mass %, and a binder preferably represents 0 to 5 mass %, more preferably 0 to 3 mass %. When a component is described herein as both a polymer electrolyte and a binder, the content of such a component is counted as the content of a polymer electrolyte.

In the composition used as the catalyst ink, the solvent preferably represents 70 to 99 mass %, more preferably 80 to 96 mass % in 100 mass % of the catalyst ink.

By control of the composition of the catalyst ink, functions and performance can be improved. For example, the decrease in electron conductivity is suppressed, and the proton conductivity, the gas diffusibility, the water transport efficiency, and the mechanical strength of the catalyst layer are improved.

Methods for fabricating the catalyst layer 103 and the catalyst layer 105 will be described. After the catalyst ink has been prepared, the catalyst ink is applied to a target substrate and is dried to form a catalyst layer. For example, the target substrate may be a solid electrolyte membrane, GDL, or a fluororesin sheet. The catalyst layers may be fabricated by a known production method. When the catalyst ink is applied to a fluororesin sheet, the catalyst layer that has been applied is transferred to the solid electrolyte. The fluororesin sheet is generally a sheet made of polytetrafluoroethylene (PTFE).

Examples of the compositions of the catalyst inks include a catalyst ink composition in which the metal catalyst is platinum, the catalyst carrier is carbon black, and the electrolytes are the fired body and Nafion (registered trademark, manufactured by DuPont) and a catalyst ink composition in which the metal catalyst is platinum, the catalyst carrier is carbon black, and the electrolyte is the fired body. Examples further include a catalyst ink composition in which the catalyst is platinum, the catalyst carriers are carbon black and the fired body or is the fired body alone, and the electrolyte is the fired body. Such a catalyst ink containing the fired body as at least part of the catalyst carrier is produced by pulverizing a catalyst ink containing the fired body and the metal catalyst to give a catalyst ink in which the metal catalyst is supported on the fired body.

The addition of the fired body eliminates or reduces the aggregation of solids, such as the catalyst, the catalyst carrier, and the fired body, in the catalyst ink, thereby enhancing the applicability of the catalyst ink.

For example, the pulverization may be dry pulverization or wet pulverization. Examples of the dry pulverization include ball milling, planetary milling, pin milling, and jet milling. Examples of the wet pulverization include ultrasonic homogenizers, ultrasonic dispersers, bead milling, sand grinding, homogenizers, and wet jet milling. Among those described above, preferred pulverization treatments are ball milling, bead milling, ultrasonic homogenizers, ultrasonic dispersers, and homogenizers. Bead milling, ultrasonic homogenizers, and ultrasonic dispersers are particularly preferable. The solvent used in the wet pulverization is not particularly limited and, for example, any of the solvents used in the catalyst ink may be used.

By fabricating a membrane-electrode assembly (MEA) using the catalyst ink containing the fired body and installing the MEA into a single cell, power generation characteristics can be obtained.

The ratio of the amount of the fired body used in the catalyst layer is calculated by the following formula. In the following calculation formula, the mass of the electrode catalyst, the fired body, the electrolyte, and the binder used for the calculation is the mass of the solids after the deduction of the mass of water and the solvent. In the following calculation formula, the electrolyte and the electrode catalyst do not include the fired body in the present invention.

$$Ratio ( mass \% ) of fired body = [ fired body ( mass ) / [ total mass ( of solids ) in catalyst layer ) ] ] \times 100 ( mass \% ) = [ fired body ( mass ) / [ electrode catalyst ( mass ) + electrolyte ( mass ) other than fired body + binder ( mass ) + fired body ( mass ) ] ] \times 100 ( mass \% )$$

The ratio of the fired body is preferably 1 to 25 mass %, and more preferably 1.5 to 20 mass %.

The mass ratio of the fired body to the electrolyte other than the fired body in the catalyst layer is preferably fired body: electrolyte other than fired body=1:1 to 1:10, and more preferably 10:12 to 1:5.

Examples of the materials for the solid electrolyte membrane 107 include the fired body, fluorinated sulfonic acid polymers, such as Nafion (registered trademark, manufactured by DuPont), Aquivion (registered trademark, manufactured by Solvay), Flemion (registered trademark, manufactured by AGC Inc.), and Aciplex (registered trademark, manufactured by Asahi Kasei Corporation), hydrocarbon-based sulfonic acid polymers, and partially fluorinated hydrocarbon-based sulfonic acid polymers.

The thickness of the solid electrolyte membrane 107 is preferably 10 to 100 μm, and more preferably 20 to 60 μm from the points of view of conductivity, durability, and gas cross leakage.

The gas diffusion layers 101 are not particularly limited. Conductive porous materials are favorably used. Examples of such materials include carbonaceous paper and nonwoven fabrics, felts, and nonwoven fabrics. The GDLs may be a material coated with a layer called a microporous layer (hereinafter, abbreviated as “MPL”) that is a coating layer based on a water-repellent resin and a carbon material. It has been reported that such a material allows for effective water transport during power generation of a fuel cell. Such a gas diffusion layer having MPL may be used for the catalyst layer including the fired body. The power generation test in the present invention involved water-repellent carbon paper that was a GDL having MPL.

### EXAMPLES

Hereinbelow, Examples and Test Examples of the present invention will be described in greater detail without limiting the scope of the present invention to such Examples.

### Example 1: Production of Fired Body (1)

A glass vessel was charged with a 1.0 mass % aqueous graphene oxide dispersion (manufactured by EMD Millipore, 60.0 g), water (60.0 g), and melamine (manufactured by NISSAN CHEMICAL CORPORATION, 1.40 g). The mixture was dispersed uniformely by ultrasonicated for 5 minutes to give a dispersion. 2-Propanol (manufactured by JUNSEI CHEMICAL CO., LTD., 480 mL) was added to a stirring vessel, and the dispersion obtained was poured into the stirring vessel while performing stirring. The resultant brown precipitates were collected by filtration. The filter cake was washed with 2-propanol three times and was dried under reduced pressure to give a dark brown powder (0.93 g, 46% recovery based on the charged mass as 100%) as a graphene oxide-melamine mixture (1a).

The graphene oxide-melamine mixture (1a) (600 mg) was added to an alumina crucible. The crucible was placed on tabletop high-speed heating electric furnace MSFT-1520-P-TR (manufactured by YAMADA DENKI CO., LTD.), heated at a heat-up rate of 10° C./min, and fired at a firing temperature of 400° C. for 2 hours. The firing gave a black fired product (201 mg, 34% recovery based on the charged mass as 100%).

### Example 2: Production of Fired Body (2)

A glass vessel was charged with a 1.0 mass % aqueous graphene oxide dispersion (manufactured by EMD Millipore, 20.0 g), water (10.0 g), melamine (manufactured by NISSAN CHEMICAL CORPORATION, 0.4 g), and phloroglucinol (Tokyo Chemical Industry Co., Ltd., 0.2 g). The mixture was dispersed uniformely by ultrasonicated for 5 minutes to give a dispersion. The dispersion obtained was placed on a hot plate set at 90° C., and the dispersion medium was distilled off while performing stirring. The residue was dried under reduced pressure to give a dark brown powder (0.79 g, 99% recovery based on the charged mass as 100%) as a graphene oxide-melamine-phloroglucinol mixture (2a).

The graphene oxide-melamine-phloroglucinol mixture (2a) (0.40 g) was added to an alumina crucible. The crucible was placed on tabletop high-speed heating electric furnace MSFT-1520-P-TR (manufactured by YAMADA DENKI CO., LTD.), heated at a heat-up rate of 10° C./min, and fired at a firing temperature of 400° C. for 2 hours. The firing gave a black fired product (0.16 g, 41% recovery based on the charged mass as 100%).

### Example 3: Production of Fired Body (3)

A glass vessel was charged with a 1.0 mass % aqueous graphene oxide dispersion (manufactured by EMD Millipore, 16.1 g), melamine (manufactured by NISSAN CHEMICAL CORPORATION, 152.0 mg), tris(acetylacetonato) cerium (III) trihydrate (manufactured by FUJIFILM Wako Pure Chemical Corporation, 171.7 mg), and water (6.0 g). The mixture was ultrasonicated for 30 minutes to give a dispersion. The dispersion obtained was placed on a hot plate set at 125° C., and part of the dispersion medium was distilled off. The dispersion was then added to an alumina crucible. The crucible was placed on tabletop high-speed heating electric furnace MSFT-1520-P-TR (manufactured by YAMADA DENKI CO., LTD.), heated at a heat-up rate of 10° C./min, and fired at a firing temperature of 400° C. for 2 hours. The firing gave a black fired product (104.1 mg, 22% recovery based on the charged mass as 100%).

### Comparative Example 1: Production of Mixture (1a)

The procedures in Example 1 were repeated, except that firing was not performed. A graphene oxide-melamine mixture (1a) was thus obtained.

### Comparative Example 2: Production of Mixture (2a)

The procedures in Example 2 were repeated, except that firing was not performed. A graphene oxide-melamine-phloroglucinol mixture (2a) was thus obtained.

In the following Test Examples, a power generation test was carried out in the following manner.

### <Fuel Cell Power Generation Test A>

MEA was fabricated and was installed into a single cell (JARI standard cell manufactured by FC Development Co., Ltd.) having an electrode area of 1 cm², and the cell was subjected to a fuel cell power generation test. On fuel cell evaluation system (AutoPEM manufactured by TOYO Corporation), the evaluation was made at a temperature of 80° C., a relative humidity of 95%, a hydrogen gas flow rate of 0.10 L/min, and an air gas flow rate of 0.33 L/min to measure the current density and the voltage.

### Test Example 1 (Power Generation Test Using Fired Body (1))

A catalyst ink was prepared using platinum-supported carbon as an electrode catalyst (product name: “TEC10E50E”, manufactured by Tanaka Kikinzoku Kogyo, platinum content: 46.5 mass %), the fired body (1) obtained in Example 1, a Nafion dispersion solution (product name: “5% Nafion Dispersion Solution DE520 CS type”, manufactured by Wako Pure Chemical Industries, Ltd.), and 2-propanol (manufactured by Wako Pure Chemical Industries, Ltd.). The electrode catalyst, the fired body, the Nafion dispersion solution, and 2-propanol were added in this order to a glass vial bottle, and the resultant dispersion solution was ultrasonicated with ultrasonic cleaner ASU-6 manufactured by AS ONE for 30 minutes with the oscillation power set at High. A catalyst ink was thus prepared.

The catalyst ink preparation conditions are described below.

Catalyst ink preparation conditions:

$$Ratio ( mass \% ) of Nafion = [ solid Nafion ( mass ) / [ electrode catalyst ( mass ) + solid Nafion ( mass ) + fired body ( mass ) ] ] \times 100 ( mass \% )$$

The masses were controlled so that the above ratio would be 29 mass %.

$$Ratio ( mass \% ) of fired body = [ fired body ( mass ) / electrode catalyst ( mass ) + solid Nafion ( mass ) + fired body ( mass ) ] ] \times 100 ( mass \% )$$

The masses were controlled so that the above ratio would be 16 mass %. Specifically, provided that the mass of the electrode catalyst was 27.5 mg, the catalyst ink was prepared while controlling the amount of the Nafion dispersion solution to 294.8 mg, the amount of the fired body (1) to 8.0 mg, and the amount of 2-propanol to 1 mL. The Nafion dispersion solution (294.8 mg) corresponds to 14.7 mg of solid Nafion.

Catalyst ink application conditions (preparation of decals):

The catalyst ink was applied with an applicator to a table having a target Teflon (registered trademark) sheet with an area of 6.5 cm×6.5 cm and a thickness of 130 μm. The whole amount of the catalyst ink prepared was used, and thereby a decal was prepared in which a catalyst layer containing 0.3 mg of platinum per cm² was supported on the Teflon sheet. The decal sheet was cut into 1 cm×1 cm decals. The ink containing the fired body (1) exhibited good applicability.

MEA fabrication process:

A membrane-electrode assembly (hereinafter, abbreviated as “MEA”) was fabricated using a solid electrolyte membrane, a gas diffusion layer (hereinafter, abbreviated as “GDL”), and the decals prepared with the catalyst ink. The GDL used here was carbon paper with MPL (product name: “28BC”, manufactured by SGL CARBON Japan Ltd.).

A 5 cm×5 cm square Nafion 211 membrane (registered trademark, manufactured by DuPont, thickness: 25 μm) as the solid electrolyte membrane was arranged in the middle, and the decals (area: 1 cm×1 cm) having the catalyst layer on the Teflon sheet were placed on both sides of the membrane. The unit was thermocompression bonded under conditions where the temperature of the upper and lower platens was 132° C., the load was 0.6 kN, and the compression time was 120 seconds. The Teflon sheets were removed. Thus, a catalyst-coated membrane (hereinafter, abbreviated as “CCM”) was fabricated. The basis weights of platinum on the anode and the cathode were determined by the difference between the mass of the decal and the mass after the transfer.

The carbon paper as GDL (product name: “28BC”, manufactured by SGL CARBON Japan Ltd., area: 1 cm×1 cm) was applied to the anode side and the cathode side in such a manner that the MPL side would be directed to the electrolyte membrane. The JARI standard cell was tightened with a torque wrench to 4 Nm with increments of 1 Nm, and thereby the GDLs and the CCM were pressure-fitted to one another.

The MEA thus fabricated was subjected to the fuel cell power generation test A. The results of open circuit voltage, voltage, and current density are described in Table 1. The open circuit voltage (hereinafter, also written as OCV) is a voltage when no voltage or no current is applied to the single cell.

### Test Example 2

An MEA was fabricated in the same manner as in Test Example 1, except that the catalyst ink in Test Example 2 was prepared using the fired body (2) (8.0 mg) obtained in Example 2 in place of the fired body (1). The ink containing the fired body (2) exhibited good applicability. The MEA thus fabricated was subjected to the fuel cell power generation test A. The results of OCV, voltage, and current density are described in Table 1.

### Test Example 3

An MEA was fabricated in the same manner as in Test Example 1, except that the catalyst ink in Test Example 3 was prepared using the fired body (3) (8.0 mg) obtained in Example 3 in place of the fired body (1). The ink containing the fired body (3) exhibited good applicability. The MEA thus fabricated was subjected to the fuel cell power generation test A. The results of OCV, voltage, and current density are described in Table 1.

### Comparative Test Example 1 and Comparative Test Example 2

MEAs were fabricated in the same manner as in Test Example 1, except that, in Comparative Test Example 1, the catalyst ink was prepared using the graphene oxide-melamine mixture (1a) (8.0 mg) obtained in Comparative Example 1 in place of the fired body (1) and, in Comparative Test Example 2, the catalyst ink was prepared using the graphene oxide-melamine-phloroglucinol mixture (2a) (8.0 mg) in place of the fired body (1). The inks containing the mixture (1a) or the mixture (2a) had applicability but contained aggregates that caused visible unevenness nearby on the coating. Furthermore, the transferability of the decals tended to be poor. The MEAs thus fabricated were subjected to the fuel cell power generation test A. The results of OCV, voltage, and current density are described in Table 1.

TABLE 1

| | Power generation test | | | | |
|---|---|---|---|---|---|
| | Test | Test | Test | Comparative Test | Comparative Test |
| | Example 1 | Example 2 | Example 3 | Example 1 | Example 2 |
| | Material | | | | |
| | Fired body | Fired body | Fired body | Mixture | Fired body |
| | (1) | (2) | (3) | (1a) | (2a) |
| | Open circuit voltage (V) | | | | |
| Current density | 0.93 | 0.93 | 0.94 | 0.90 | 0.91 |
| (A/cm²) | Voltage (V) | Voltage (V) | Voltage (V) | Voltage (V) | Voltage (V) |
| 0.20 | 0.78 | 0.78 | 0.78 | 0.68 | 0.72 |
| 0.40 | 0.73 | 0.72 | 0.73 | 0.56 | 0.61 |
| 0.60 | 0.68 | 0.68 | 0.67 | 0.45 | 0.51 |
| 0.80 | 0.62 | 0.63 | 0.62 | 0.36 | 0.41 |
| 1.00 | 0.58 | 0.58 | 0.57 | 0.24 | 0.29 |
| 1.05 | — | — | — | 0.20 | — |
| 1.15 | — | — | — | — | 0.20 |
| 1.20 | 0.51 | 0.52 | 0.50 | — | — |
| 1.40 | 0.41 | 0.44 | 0.42 | — | — |
| 1.60 | 0.25 | 0.32 | 0.31 | — | — |

The comparison of Test Examples 1 and 2 with Comparative Test Examples 1 and 2 has shown that the fired bodies of the present invention improve ink applicability and also improve power generation characteristics. In Comparative Test Example 1 and Comparative Test Example 2, the voltage dropped with increasing current density. In contrast, the power generation test of the inventive fired bodies of Test Examples 1 to 3 showed that the voltage remained above 0.6 V even when the current density was 0.8 (A/cm²). The reason behind this is probably because the use of the fired body of the present invention in the catalyst layer improved the transport of generated water, the diffusion of fuel oxygen (air), and proton conductivity. While the open circuit voltage tended to be low in Comparative Test Example 1 and Comparative Test Example 2, the values in Test Examples 1 to 3 were higher probably because of improved conductivity.

### REFERENCE EXAMPLE

The fired body (1) and graphene oxide after the evaporation of the dispersion medium were subjected to thermal mass measurement. Rigaku Thermoplus EVO TG8120 (manufactured by Rigaku Corporation) was used as a thermal analyzer. A platinum pan was used as a sample container, and about 5 mg of aluminum oxide was used as the standard substance. In an air atmosphere, a sample weighing 5 mg was heated at a heat-up rate of 10.0° C./min, and changes in mass were measured. Table 1 describes the loss (%) in the mass at the elevated temperatures.

TABLE 2

| Temperature (° C.) | 200 | 300 | 400 |
|---|---|---|---|
| Mass change of | 44% loss | 59% loss | 73% loss |
| fired body (1) | | | |
| Mass change of | 70% loss | 91% loss | 94% loss |
| graphene oxide | | | |

Compared to graphene oxide, the fired body (1) lost less mass at the elevated temperatures. When, for example, the temperature was 300° C., the fired body (1) maintained 40% mass but the mass of graphene oxide decreased to less than 10%. As described above, firing of the nitrogen-containing compound component, for example, melamine (i) removes ammonia to form melam represented by formula (ii), and the condensation product is further deammoniated into melem represented by formula (iii), the compounds represented by formula (iv) or formula (v), and melons represented by formula (vi), formula (vii), or formula (viii). The above results will indicate that in the fired body (1), the products formed by these processes were entangled with one another on the graphene sheets.

### INDUSTRIAL APPLICABILITY

The fired bodies of the present invention are useful as, for example, fuel cell electrolyte materials (for example, electrolytes and catalyst carriers used in catalyst layers, and electrolytes for solid electrolyte membranes) and are expected to offer improvements in power generation characteristics and durability of fuel cells.

### DESCRIPTION OF REFERENCE NUMERALS

100 fuel cell
101 gas diffusion layer
103 anode catalyst layer
105 cathode catalyst layer
107 solid electrolyte membrane
109 separator

1. A fired body of a mixture comprising graphene oxide and a nitrogen-containing compound component.

2. The fired body according to claim 1, wherein the mixture further comprises an aromatic compound having a phenolic hydroxyl group.

3. The fired body according to claim 1, wherein the mixture further comprises a rare earth metal compound.

4. The fired body according to claim 1, wherein the nitrogen-containing compound component is at least one kind selected from the group consisting of nitrogen-containing compounds, salts of nitrogen-containing compounds, and resins containing a constituent unit derived from a nitrogen-containing compound.

5. The fired body according to claim 2, wherein the aromatic compound having a phenolic hydroxyl group is an aromatic compound having 3 to 6 phenolic hydroxyl groups.

6. The fired body according to claim 3, wherein the metal in the rare earth metal compound is at least one kind selected from the group consisting of scandium, yttrium, lanthanum, cerium, praseodymium, neodymium, promethium, samarium, europium, gadolinium, terbium, dysprosium, holmium, erbium, thulium, ytterbium, and lutetium.

7. The fired body according to claim 1, which comprises a three-dimensional polymer of the nitrogen-containing compound.

8. The fired body according to claim 2, which comprises a three-dimensional polymer of the aromatic compound having a phenolic hydroxyl group.

9. The fired body according to claim 1, which is at least one kind of an electrolyte in a catalyst layer, a catalyst carrier in a catalyst layer, or an electrolyte in a solid electrolyte membrane, in a polymer electrolyte fuel cell.

10. A composition comprising the fired body according to claim 1 and a metal catalyst.

11. The composition according to claim 10, which is for use in a catalyst layer for a polymer electrolyte fuel cell.

12. A catalyst layer for a polymer electrolyte fuel cell, the catalyst layer comprising the composition according to claim 11.

13. A membrane-electrode assembly comprising a solid electrolyte membrane, a gas diffusion layer, and the catalyst layer for a polymer electrolyte fuel cell according to claim 12.

14. A polymer electrolyte fuel cell comprising the membrane-electrode assembly according to claim 13.
